(19) United States
(12) Patent Application Publication
(10) Pub. No.: US 2023/0197317 A1
(43) Pub. Date: Jun. 22, 2023

(54) METHOD FOR PRODUCING FILM AND CONDUCTIVE FILM

(71) Applicant: Murata Manufacturing Co., Ltd., Nagaokakyo-shi (JP)

(72) Inventor: Masanori ABE, Nagaokakyo-shi (JP)

(21) Appl. No.: 18/165,555

(22) Filed: Feb. 7, 2023

Related U.S. Application Data
(63) Continuation of application No. PCT/JP2021/029149, filed on Aug. 5, 2021.

(30) Foreign Application Priority Data
Aug. 13, 2020 (JP) 2020-136824

(51) Int. Cl. H01B 13/00; H01B 13/32; H01B 1/02; H01B 1/06

(52) U.S. Cl. CPC H01B 13/0026; H01B 13/0036; H01B 13/32; H01B 1/02; H01B 1/06

(57) ABSTRACT

A method for producing a film, the method including separately discharging a slurry containing particles of a layered material in a liquid medium and a gas from a nozzle, causing the slurry and the gas to collide with each other outside the nozzle, and depositing the particles of the layered material on a substrate to form the film. A concentration of the particles of the layered material in the slurry may be 30 mg/mL or more.

### CROSS REFERENCE TO RELATED APPLICATIONS

The present application is a continuation of International application No. PCT/JP2021/029149, filed Aug. 5, 2021, which claims priority to Japanese Patent Application No. 2020-136824, filed Aug. 13, 2020, the entire contents of each of which are incorporated herein by reference.

### FIELD OF THE INVENTION

The present invention relates to a method for producing a film and a conductive film.

### BACKGROUND OF THE INVENTION

In recent years, MXene, graphene, black phosphorus, and the like have attracted attention as layered materials having a form of one or more layers, so-called two-dimensional materials. MXene is a novel material having conductivity, and is a layered material having a form of one or more layers as will be described later. In general, MXene is in the form of particles (which can include powders, flakes, nanosheets, and the like) of such a layered material.

It is known that particles of a layered material (two-dimensional material) such as MXene can be formed into a film on a substrate by subjecting the particles to suction filtration or spray coating in a slurry state (refer to FIG. 7 of Non-Patent Document 1). Compared to suction filtration, spray coating is suitable for producing films industrially.

Non-Patent Document 1: Mohamed Alhabeb et al., “Guidelines for Synthesis and Processing of Two-Dimensional Titanium Carbide (Ti₃C₂Tₓ MXene)”, Chemistry of Materials, 2017, Volume 29, Issue 18, pp. 7633-7644

### SUMMARY OF THE INVENTION

However, in suction filtration or spray coating used in the related art for forming a film containing particles of a layered material (two-dimensional material) on a substrate, the particles are present in a relatively disordered manner in the obtained film, and sufficient orientation is not necessarily obtained (refer to FIG. 9). The film containing particles of the layered material may have different physical properties depending on the orientation of the particles of the layered material in the film. In order to effectively exhibit the characteristics of the layered material, it is considered preferable that the orientation of the particles of the layered material in the film is high. For example, in a case of MXene, if the orientation of the MXene particles in the film is high, it is considered that a conductive film having higher conductivity can be obtained.

An object of the present invention is to provide a method capable of producing a film containing particles of a layered material and having high particle orientation in the film. Another object of the present invention is to provide a conductive film which contains MXene and has higher conductivity.

According to one gist of the present invention, there is provided a method for producing a film comprising separately discharging a slurry containing particles of a layered material in a liquid medium and a gas from a nozzle, causing the slurry and the gas to collide with each other outside the nozzle, and depositing the particles of the layered material on a substrate to form the film.

In one aspect of the present invention, a concentration of the particles of the layered material in the slurry is 30 mg/mL or more.

In one aspect of the present invention, the nozzle can have a configuration in which the slurry and the gas collide with each other in a vortex outside the nozzle.

In one aspect of the present invention, the one or plural layers include a layer body represented by: MₘXₙ,wherein M is at least one metal of Group 3, 4, 5, 6, or 7; X is a carbon atom, a nitrogen atom, or a combination thereof; n is 1 to 4, and m is more than n and 5 or less; and a modifier or terminal T exists on a surface of the layer body, wherein T is at least one selected from the group consisting of a hydroxyl group, a fluorine atom, a chlorine atom, an oxygen atom, or a hydrogen atom.

According to another gist of the present invention, there is provided a conductive film containing particles of a layered material including one or plural layers, wherein the one or plural layers include a layer body represented by: MₘXₙ, wherein M is at least one metal of Group 3, 4, 5, 6, or 7; X is a carbon atom, a nitrogen atom, or a combination thereof; n is 1 to 4; and m is more than n and 5 or less; and a modifier or terminal T exists on a surface of the layer body, wherein T is at least one selected from the group consisting of a hydroxyl group, a fluorine atom, a chlorine atom, an oxygen atom, or a hydrogen atom; and an χ-axis direction rocking curve half-value width for a peak of a (00l) plane obtained by X-ray diffraction measurement of the conductive film is 20° or less, where the l of the (00l) plane is a natural number multiple of 2; and wherein the conductive film has a conductivity of 3,000 S/cm or more.

In one aspect of the present invention, the conductive film can be used as an electrode or an electromagnetic shield.

The conductive film of the present invention can be produced by the method for producing the film of the present invention.

According to the present invention, it is possible to produce a film containing particles of a layered material and having high orientation of the particles in the film, wherein the film is obtained by separately discharging a slurry containing the particles of the layered material in a liquid medium and a gas from a nozzle, causing the slurry and the gas to collide with each other outside the nozzle, and depositing the particles of the layered material on a substrate. According to the present invention, there is also provided a conductive film including particles of a predetermined layered material (also referred to as “MXene” in the present specification) and having a high conductivity.

### BRIEF DESCRIPTION OF THE DRAWINGS

FIG. 1 is a schematic view for explaining a method for producing a film in one embodiment of the present invention.

FIG. 2 is a schematic cross-sectional view illustrating one example of an external mixing type multi-fluid nozzle that can be used in one embodiment of the present invention.

FIG. 3 is a schematic cross-sectional view illustrating another example of the external mixing type multi-fluid nozzle that can be used in one embodiment of the present invention.

FIG. 4 is a schematic partial cross-sectional view illustrating still another example of the external mixing type multi-fluid nozzle that can be used in one embodiment of the present invention.

FIGS. 5(a) and 5(b) are schematic views for explaining an example of details of the external mixing type multi-fluid nozzle illustrated in FIG. 4, in which FIG. 5(a) is a schematic exploded view of the external mixing type multi-fluid nozzle, and FIG. 5(b) is a schematic cross-sectional view of the external mixing type multi-fluid nozzle.

FIGS. 6(a) and 6(b) are views illustrating a film produced in one embodiment of the present invention, in which FIG. 6(a) illustrates a schematic cross-sectional view of the film on a substrate, and FIG. 6(b) illustrates a schematic perspective view of a layered material in the film.

FIGS. 7(a) and 7(b) are schematic cross-sectional views illustrating MXene particles which are layered materials usable in one embodiment of the present invention, in which FIG. 7(a) illustrates single-layered MXene particles, and FIG. 7(b) illustrates multi-layered (exemplarily two-layered) MXene particles.

FIG. 8 is a schematic view for explaining an example of an internal mixing type multi-fluid nozzle.

FIG. 9 is a view for explaining a film produced using an internal mixing type multi-fluid nozzle, and illustrates a schematic cross-sectional view of a film on a substrate.

### DETAILED DESCRIPTION OF PREFERRED EMBODIMENTS OF THE INVENTION

### EMBODIMENT 1: Method for Producing Film

Hereinafter, a method for producing a film in one embodiment of the present invention will be described in detail, but the present invention is not limited to such an embodiment.

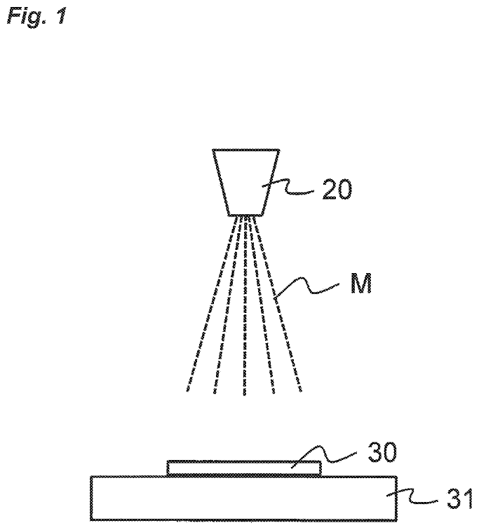

Referring to FIG. 1, a method for producing a film of the present embodiment is a method for producing a film 30 including particles of a layered material including one or more layers, the method comprising separately discharging a slurry (fluid) containing the particles of the layered material in a liquid medium and a gas (another fluid) from a nozzle 20, causing the slurry and the gas to collide with each other (thereby being mixed) outside the nozzle 20, and depositing the particles of the layered material on a substrate 31 to form the film 30.

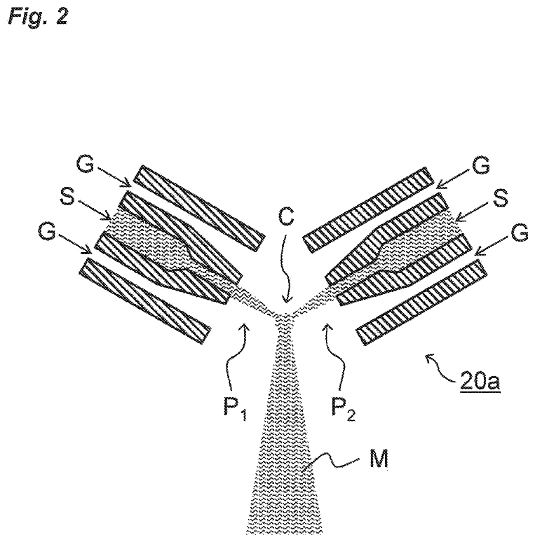

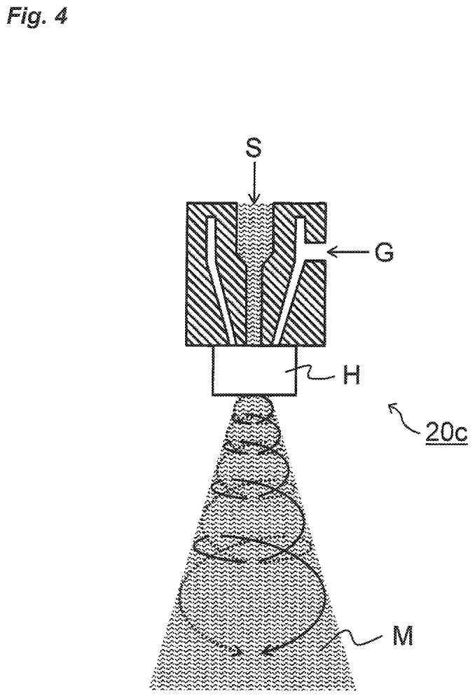

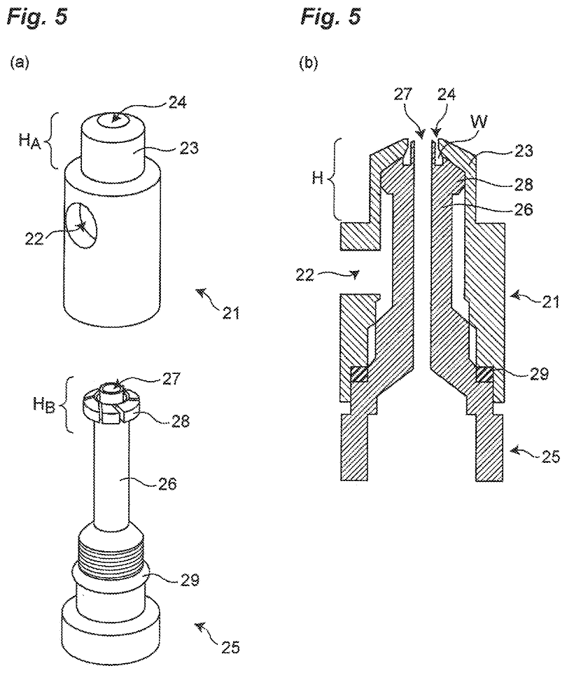

More specifically, the nozzle 20 available in the present embodiment is a nozzle referred to as an external mixing type multi-fluid nozzle. While not limiting the present embodiment, various examples of external mixing type multi-fluid nozzles are illustrated in FIGS. 2 to 5. The nozzle 20 preferably has a configuration in which the slurry and the gas collide with each other in a vortex outside the nozzle 20 (to be described later with reference to FIGS. 4 and 5).

Referring to FIG. 2, an external mixing type multi-fluid nozzle 20a has two-fluid nozzle portions P₁ and P₂ arranged to face each other with discharge directions forming an angle (for example, θ=10 to 170°. These two-fluid nozzle portions P₁ and P₂ may be configured independently of each other, but may be connected to each other upstream to configure one nozzle as a whole. By using the nozzle 20a, a mist M containing the particles of the layered material can be sprayed from the mixed fluid of the slurry S and the gas G as follows. In the nozzle 20a, the slurry S and the gas G are separately discharged, and first collide with each other at each of the two-fluid nozzle portions P₁ and P₂ (the slurry is atomized). Then, the mixed fluid (including the first atomized slurry) formed in each of the two-fluid nozzle portions P₁ and P₂ is discharged forward as it is from each of the two-fluid nozzle portions P₁ and P₂, and collides with each other at or near an intersection point C (the slurry is further atomized). Then, the mixed fluid (second atomized slurry) formed at or near the intersection point C is sprayed from the nozzle 20a as the mist M containing the particles of the layered material. Such an external mixing type multi-fluid nozzle 20a may be a collision type nozzle (for example, available from H.IKEUCHI Co., Ltd., KIRI NO IKEUCHI (registered trademark), AKIJet (registered trademark) series) or the like.

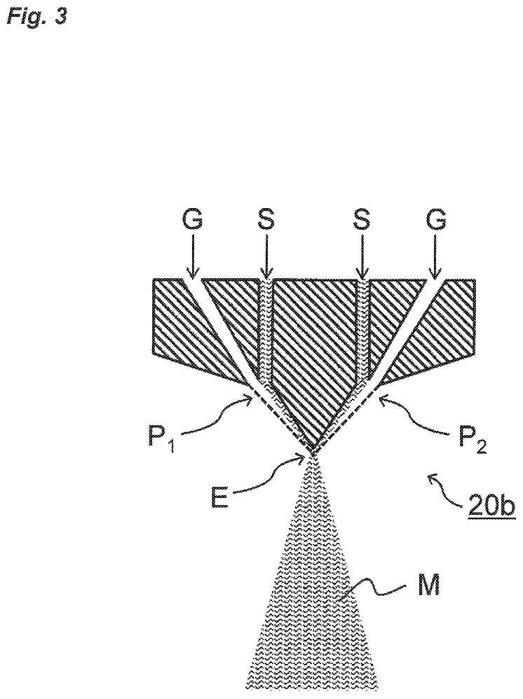

Referring to FIG. 3, the external mixing type multi-fluid nozzle 20b has two-fluid nozzle portions P₁ and P₂ and an edge portion E, and can be configured as one nozzle as a whole. By using the nozzle 20b, a mist M containing the particles of the layered material can be sprayed from the mixed fluid of the slurry S and the gas G as follows. In the nozzle 20b, the slurry S and the gas G are separately discharged, and first collide with each other at each of the two-fluid nozzle portions P₁ and P₂ (the slurry is atomized). Then, the mixed fluid (including the first atomized slurry) formed in each of the two-fluid nozzle portions P₁ and P₂ flows along the nozzle surface from each of the two-fluid nozzle portions P₁ and P₂ to the edge portion E, and collides with each other at the edge portion E (the slurry is further atomized). Then, the mixed fluid (second atomized slurry) formed at the edge portion E is sprayed from the nozzle 20b as the mist M containing the particles of the layered material. Such the external mixing type multi-fluid nozzle 20b may be a twin jet nozzle (for example, Twin Jet Nozzle RJ series available from OHKAWARA KAKOHKI CO., LTD.), a four-fluid nozzle (for example, a four-fluid nozzle available from GF Corporation), or the like.

Referring to FIG. 4, the external mixing type multi-fluid nozzle 20c is an external mixing vortex type multi-fluid nozzle having a configuration in which the slurry S and the gas G collide with each other in a vortex outside the nozzle 20c. More specifically, the external mixing type multi-fluid nozzle 20c has a head portion H configured to discharge the slurry S and allow it to collide with the gas G separately discharged as a vortex (preferably a high-speed swirling vortex). For example, by using the nozzle 20c, a mist M containing the particles of the layered material can be sprayed from the mixed fluid of the slurry S and the gas G as follows. In the nozzle 20c, the gas G is passed through one or more spiral grooves (not shown in FIG. 4) provided in a swirling member (not shown in FIG. 4) incorporated in the head portion H and discharged from a gas discharge port (not shown in FIG. 4), whereby a high-speed swirling vortex of the gas G is generated. The slurry S is introduced into a fluid supply pipe inside the nozzle 20c provided for the slurry S by the negative pressure of the high-speed swirling vortex by the gas G, and is discharged from the fluid discharge port (not shown in FIG. 4) at a tip of the fluid supply pipe. Then, in front of the head portion H of the nozzle 20c, the slurry S discharged from the fluid discharge port collides with the high-speed swirling vortex caused by the gas G discharged from the gas discharge port (the slurry is atomized). The mixed fluid (including atomized slurry) formed in front of the head portion H is sprayed from the nozzle 20c as the mist M containing the particles of the layered material. Such an external mixing type multi-fluid nozzle 20c may be an external mixing vortex type multi-fluid nozzle (for example, Atomax nozzle available from ATOMAX.INC) or the like.

FIG. 5 illustrates an example of an external mixing type multi-fluid nozzle 20c (in FIG. 5, the upper and lower sides of the nozzle are reversed from those in FIG. 4.). In the example illustrated in FIG. 5, the external mixing type multi-fluid nozzle 20c may be configured by a nozzle body 21 and a core member 25, and the head portion H may be configured by an outer head portion HA of the nozzle body 21 and an inner head portion HB of the core member 25. The nozzle body 21 may have a gas supply port 22, a nozzle tip portion 23, and a gas discharge port 24. The core member 25 may have a fluid supply pipe 26, a fluid discharge port 27, a swirling member 28 provided around the fluid supply pipe 26 in the vicinity of the fluid discharge port 27, and a packing 29 provided around the fluid supply pipe 26 on the opposite side of the swirling member 28. The swirling member 28 is provided with a plurality of spiral grooves (refer to FIG. 5(a)). In a state in which the nozzle body 21 and the core member 25 are combined to constitute the external mixing type multi-fluid nozzle 20c (refer to FIG. 5(b)), the inner surface of the nozzle tip portion 23 and the outer surface of the swirling member 28 (excluding the wall surface without the spiral groove) are in contact with each other to form the gas flow path (not shown in FIG. 5(b)) including the spiral groove, and the nozzle body 21 and the core member 25 are airtightly fitted by the packing 29 (further, screw portions provided corresponding to nozzle body 21 and core member 25) below the gas supply port 22 (on the side opposite to the head portion H). The gas G is supplied from the gas supply port 22, passes through the space between the inner surface of the nozzle body 21 and the outer surface of the fluid supply pipe 26, and the spiral groove of the swirling member 28, passes through a vortex chamber W, and is discharged from the gas discharge port 24 in the form of a high-speed swirling vortex. On the other hand, the slurry S passes through the inside of the fluid supply pipe 26 and is discharged from the fluid discharge port 27 at the distal end of the fluid supply pipe 26. As a result, in front of the head portion H, the slurry S discharged from the fluid discharge port 27 collides with the high-speed swirling vortex caused by the gas G discharged from the gas discharge port 24 (the slurry is atomized). The mixed fluid (including atomized slurry) formed in front of the head portion H is sprayed from the nozzle 20c as the mist M containing the particles of the layered material.

In this manner, the slurry S containing the particles of the layered material in the liquid medium and the gas G are separately discharged from the nozzle 20 by the nozzle 20 and collided with each other outside the nozzle 20, whereby the slurry S can be made into an extremely fine and homogeneous mist M, and strong shear force can be applied to the particles of the layered material. As a result, when the particles of the layered material are aggregated, the aggregation can be released, and when the particles of the layered material are overlapped with each other, the overlap can be released. Further/alternatively, in a case where the particles are particles having a multilayer structure, layer separation (delamination) can be performed.

The particles of the layered material contained in the slurry S are preferably particles of a predetermined layered material (MXene) to be described later in Embodiment 2. However, the layered material is not limited thereto, and may be, for example, graphene, graphite, black phosphorus, boron nitride, molybdenum sulfide, tungsten sulfide, graphene oxide, or the like, and the particle size of these particles may be appropriately selected. In the present invention, the “layered material” is a material containing a compound having a two-dimensional expansion as a main component (it may have modifier/terminal, and may contain relatively small amounts of additives and the like.), and is understood as a so-called two-dimensional material.

The slurry S may be a dispersion and/or a suspension containing the particles 10 of the layered material in a liquid medium. The liquid medium may be an aqueous medium and/or an organic medium, and is preferably an aqueous medium. The aqueous medium is typically water, and in some cases, other liquid substances may be contained in a relatively small amount (for example, 30 mass % or less, preferably 20 mass % or less based on the whole mass of aqueous medium) in addition to water. The organic medium may be, for example, N-methylpyrrolidone, N-methylformamide, N,N-dimethylformamide, ethanol, methanol, dimethylsulfoxide, ethylene glycol, acetic acid, or the like.

The concentration of the particles 10 of the layered material in the slurry S may be, for example, 5 mg/mL or more, but in particular can be 30 mg/mL or more without causing nozzle clogging, since the agglomeration/overlap of the particles can be released and optionally the layers can be separated as described above. As the concentration of the particles 10 of the layered material in the slurry S is higher, the film 30 having a desired thickness can be produced in a shorter time, and is suitable for industrial mass production. The upper limit of the concentration of the particles 10 of the layered material can be appropriately selected, but can be, for example, 200 mg/mL or less. The concentration of the particles 10 of the layered material is understood as a solid content concentration in the slurry S when it is assumed that no solid content is present in the slurry S other than the particles 10 of the layered material, and the solid content concentration can be measured using, for example, a heating dry weight measurement method, a freeze dry weight measurement method, a filtration weight measurement method, or the like.

The slurry S may be supplied to the nozzle 20 by either a pressurization method or a suction method.

The gas G is not particularly limited, and may be, for example, air, nitrogen gas, or the like. The pressure of the gas G can be appropriately set, and may be, for example, 0.05 to 1.0 MPa (gauge pressure).

The particle size of the mist M can be appropriately adjusted, and may be, for example, 1 μm to 15 μm.

The mist M sprayed from the nozzle 20 is supplied (applied) onto the substrate 31 (more specifically, the substrate surface 31a) (spray coating), and particles of a layered material are deposited on the substrate 31 to form the film 30. The liquid components contained in the mist M (derived from the liquid medium of the slurry S) may be at least partially, preferably entirely, removed by drying while and/or after being fed onto the substrate 31.

The substrate is not particularly limited, and may be made of any suitable material. The substrate may be, for example, a resin film, a metal foil, a printed wiring board, a mounted electronic component, a metal pin, a metal wiring, a metal wire, or the like.

Drying may be performed under mild conditions such as natural drying (typically, it is disposed in an air atmosphere at normal temperature and normal pressure.) or air drying (blowing air), or may be performed under relatively active conditions such as hot air drying (blowing heated air), heat drying, and/or vacuum drying.

Spraying (which may be formation of a precursor) and drying from the nozzle 20 may be repeated as appropriate until a desired film thickness is obtained. For example, a combination of spraying and drying may be repeated a plurality of times. However, according to the embodiment, since a slurry containing the particles 10 at a relatively high concentration can be used, a relatively thick film (for example, a thickness of 0.5 μm or more) can be obtained only by performing one spray (and optionally drying), and the number of sprays (and optionally drying) performed until a desired film thickness is obtained can be reduced.

Thus, the film 30 is produced. The film 30 includes the particles 10 of layered material and may or may not substantially contain components derived from the liquid medium of the slurry S.

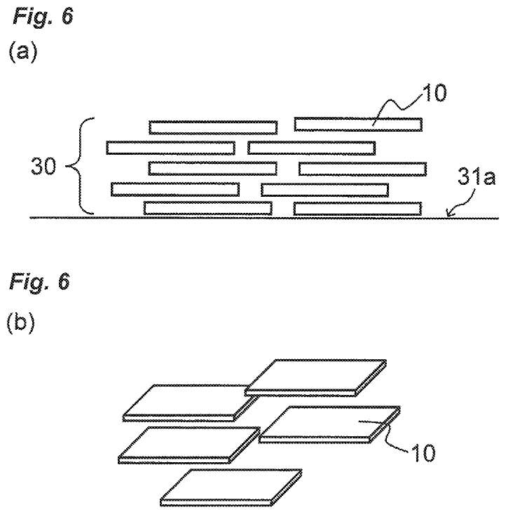

As schematically illustrated in FIG. 6, the particles 10 of the layered material exist in a relatively aligned state in the finally obtained film 30, and more specifically, there are many particles 10 in which two-dimensional sheet surfaces of the layered material (planes parallel to the layer of the layered material) are relatively aligned (preferably parallel) with respect to the substrate surface 31a (in other words, the main surface of the film 30). That is, the film 30 having high orientation of the particles 10 in the film 30 can be obtained.

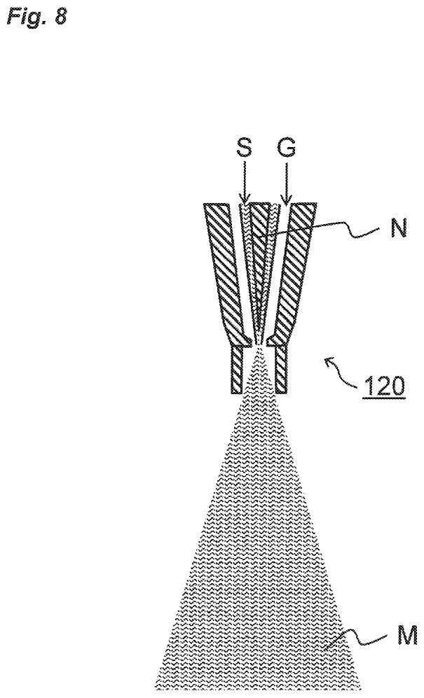

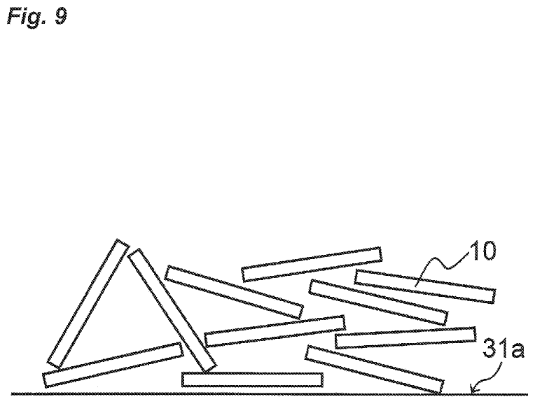

The present inventors have noted that in conventional spray coating that form a film containing particles of a layered material on a substrate, internal mixing type multi-fluid nozzles have been used. Referring to FIG. 8, in the internal mixing type multi-fluid nozzle 120, the slurry S containing the particles of the layered material in the liquid medium and the gas G are mixed inside the nozzle 120 and discharged together from the nozzle 120 (in the illustrated aspect, the slurry S and the gas G are concentrically supplied to and discharged from a needle N disposed at the center inside the nozzle 120.). As schematically illustrated in FIG. 9, the film obtained by using the internal mixing type multi-fluid nozzle has a problem that layered material particles are relatively disordered with respect to the substrate surface 31a (in other words, the main surface of the film), and orientation is low. In addition, when an attempt is made to perform the spray coating on a slurry containing the particles of the layered material in the liquid medium using the internal mixing type multi-fluid nozzle, there is also a problem that an enlarged droplet to be sprayed (so-called dripping) occurs or nozzle clogging frequently occurs. These problems appear to occur because the viscosity of the slurry is significantly increased by the application of shear force to the multilayer layered material particles that may be present in the slurry to form a single layer, forcing the slurry with such increased viscosity to be blown through the internal mixing type multi-fluid nozzle. In order to avoid nozzle clogging, only a slurry having a low particle concentration (solid content concentration) (less than 30 mg/mL) can be used, and it takes a long time to obtain a film having a desired thickness, which is not suitable for industrial mass production.

According to the study of the present inventors, it is considered that when the internal mixing type multi-fluid nozzle is used, the shear force applied to the particles of the layered material is weak, and the momentum to spray the slurry having increased viscosity is also weak, which causes the above problems.

On the other hand, according to the present embodiment, by using the external mixing type multi-fluid nozzle as described above, strong shear force can be applied to the particles of the layered material, and the momentum to blow the slurry having increased viscosity is strong, so that a film having high orientation can be produced by a method suitable for industrial mass production. In the external mixing type multi-fluid nozzle, it is considered that the problem as described above does not occur because the high-viscosity slurry is also easily blown. On the other hand, in the internal mixing type multi-fluid nozzle, it is not possible to produce a film having high orientation similarly to the external mixing type multi-fluid nozzle by simply increasing the discharge pressure.

According to the present embodiment, the film 30 having high orientation of the particles 10 of the layered material can be obtained. When a film is produced by the method of the present embodiment using a conductive material (a predetermined layered material (MXene) to be described later in Embodiment 2, graphene, or the like.) as a layered material, high conductivity can be achieved due to high orientation as compared with the case of producing a film by another method (for example, a method using an internal mixing type multi-fluid nozzle, dip coating, or the like) having low orientation, and the layered material can be used for applications in which high conductivity is required, for example, an electrode (for example, a capacitor electrode, a battery electrode, a bioelectrode, a sensor electrode, an antenna electrode, and an electrolysis electrode.) and an electromagnetic shield (EMI shield) in any appropriate electric device. In addition, when the film is produced by the method of the present embodiment (whether or not the layered material is electrically conductive), it is considered that high thermal conductivity can be achieved by high orientation as compared with the case where the film is produced by another method having low orientation.

In the producing method of the present embodiment, the slurry may be substantially made of the particles 10 of the layered material and the liquid medium, and the film obtained using such a slurry (MXene slurry) contains the particles of the layered material and optionally components derived from remaining liquid medium and is substantially free of other components (for example, so-called binder). Alternatively, in the producing method of the present embodiment, the slurry may contain any appropriate component in addition to the particles 10 of the layered material and the liquid medium, and the film obtained using such slurry may further contain the component. The other component may be, for example, a polymer, and the content ratio of the polymer in the slurry (MXene-polymer composite slurry) may be appropriately selected according to the polymer used. The polymer may be soluble and/or dispersible in the liquid medium used for the slurry and may be used with surfactants, dispersants, emulsifiers, and the like. The polymer is preferably, but not limited to, one or more polymers selected from the group consisting of, for example, polyurethane (in particular, water-soluble and/or water-dispersible polyurethanes), polyvinyl alcohol, sodium alginate, an acrylic acid-based water-soluble polymer, polyacrylamide, polyaniline sulfonic acid, or nylon. The mass ratio of the MXene particles to the polymer in the slurry (and in the film obtained thereby) is not particularly limited, but may be, for example, 1:4 or less, and preferably 1:0.01 to 3.

### EMBODIMENT 2: Conductive Film and Method for Producing the Same

Hereinafter, a conductive film and a method for producing the same in one embodiment of the present invention will be described in detail, but the present invention is not limited to such an embodiment.

Referring to FIG. 6, a conductive film 30 of the present embodiment includes particles 10 of a predetermined layered material, has an χ-axis direction rocking curve half-value width of 20° or less with respect to a peak of a (00l) plane (l is a natural number multiple of 2) obtained by X-ray diffraction measurement of the conductive film 30, and has a conductivity of 3,000 S/cm or more. Hereinafter, the conductive film of the present embodiment will be described through the producing method. Unless otherwise specified, the description of the method for producing the film of Embodiment 1 can be applied to the present embodiment in the same manner.

First, particles of a predetermined layered material are prepared. The predetermined layered material that can be used in this embodiment is MXene and is defined as:

a layered material (this can be understood as a layered compound, also represented as “MₘXₙTₛ”, where s is any number and traditionally x is sometimes used instead of s) containing one or plural layers, the one or plural layers including a layer body (the layer body may have a crystal lattice in which each X is located in an octahedral array of M) represented by:

MₘXₙ

wherein M is at least one metal of Group 3, 4, 5, 6, or 7 and may contain at least one selected from the group consisting of so-called early transition metals such as Sc, Ti, Zr, Hf, V, Nb, Ta, Cr, Mo, or Mn,

X is a carbon atom, a nitrogen atom, or a combination thereof,

n is 1 to 4, and

m is more than n and 5 or less) and a modifier or terminal T (T is at least one selected from the group consisting of a hydroxyl group, a fluorine atom, a chlorine atom, an oxygen atom, or a hydrogen atom) is present on the surface (more specifically, at least one of the two opposing surfaces of the layer body) of the layer body. Typically, n can be 1, 2, 3, or 4, but is not limited thereto.

In the above formula of MXene, M is preferably at least one selected from the group consisting of Ti, Zr, Hf, V, Nb, Ta, Cr, Mo, or Mn, and more preferably at least one selected from the group consisting of Ti, V, Cr, or Mo.

Such MXene can be synthesized by selectively etching (removing and optionally layer-separating) A atoms (and optionally parts of M atoms) from a MAX phase. The MAX phase is represented by:

MₘAXₙ

wherein M, X, n, and m are as described above, and A is at least one element of Group 12, 13, 14, 15, or 16, is usually a Group A element, typically Group IIIA and Group IVA, more specifically, may include at least one selected from the group consisting of Al, Ga, In, Tl, Si, Ge, Sn, Pb, P, As, S, or Cd, and is preferably Al), and has a crystal structure in which a layer formed of A atoms is located between two layers (each X may have a crystal lattice located within an octahedral array of M) represented by MₘXₙ. Typically, in the case of m=n+1, the MAX phase has a repeating unit in which one layer of X atoms is disposed between the layers of M atoms of n+1 layers (these layers are also collectively referred to as “MₘXₙ layer”), and a layer of A atoms (“A atom layer”) is disposed as a next layer of the (n+1) th layer of M atoms; however, the present invention is not limited thereto. By selectively etching (removing and optionally layer-separating) the A atoms (and optionally a part of the M atoms) from the MAX phase, the A atom layer (and optionally a part of the M atoms) is removed, and a hydroxyl group, a fluorine atom, a chlorine atom, an oxygen atom, a hydrogen atom, and the like existing in an etching liquid (usually, but not limited to, an aqueous solution of a fluorine-containing acid is used) are modified on the exposed surface of the MₘXₙ, layer, thereby terminating the surface. The etching can be carried out using an etching liquid containing F⁻, and a method using, for example, a mixed liquid of lithium fluoride and hydrochloric acid, a method using hydrofluoric acid, or the like may be used. Thereafter, the layer separation (delamination, separating multilayer MXene into single-layer MXene) of MXene may be promoted by any appropriate post-treatment (for example, ultrasonic treatment, handshaking, automatic shaker, or the like) as appropriate. Since the shear force of an ultrasonic treatment is too large so that the MXene particles can be destroyed (can be broken into small pieces), it is desirable to apply appropriate shear force by handshake, an automatic shaker or the like, when it is desired to obtain a two-dimensional MXene particles (preferably single-layer MXene particles) having a larger aspect ratio.

MXenes whose above formula MₘXₙ is expressed as below are known:

Sc₂C, Ti₂C, Ti₂N, Zr₂C, Zr₂N, Hf₂C, Hf₂N, V₂C, V₂N, Nb₂C, Ta₂C, Cr₂C, Cr₂N, Mo₂C, Mo_{1.3}C, Cr_{1.3}C, (Ti,V)₂C, (Ti,Nb)₂C, W₂C, W_{1.3}C, Mo₂N, Nb_{1.3}C, Mo_{1.3}Y_{0.6}C (in the above formula, “1.3” and “0.6” mean about 1.3 (=4/3) and about 0.6 (=2/3), respectively.), Ti₃C₂, Ti₃N₂, Ti₃(CN), Zr₃C₂, (Ti,V)₃C₂, (Ti₂Nb)C₂, (Ti₂Ta)C₂, (Ti₂Mn)C₂, Hf₃C₂, (Hf₂V)C₂, (Hf₂Mn)C₂, (V₂Ti)C₂, (Cr₂Ti)C₂, (Cr₂V)C₂, (Cr₂Nb)C₂, (Cr₂Ta)C₂, (Mo₂Sc)C₂, (Mo₂Ti)C₂, (Mo₂Zr)C₂, (Mo₂Hf)C₂, (Mo₂V)C₂, (Mo₂Nb)C₂, (Mo₂Ta)C₂, (W2Ti)C₂, (W₂Zr)C₂, (W₂Hf)C₂,

Ti₄N₃, V₄C₃, Nb₄C₃, Ta₄C₃, (Ti,Nb)₄C₃, (Nb,Zr)₄C₃, (Ti₂Nb₂)C₃, (Ti2Ta₂)C₃, (V₂Ti₂)C₃, (V₂Nb₂)C₃, (V₂Ta₂)C₃, (Nb2Ta₂)C₃, (Cr₂Ti₂)C₃, (Cr₂V₂)C₃, (Cr₂Nb₂)C₃, (Cr₂Ta₂)C₃, (Mo₂Ti₂)C₃, (Mo₂Zr2)C₃, (Mo₂Hf₂)C₃, (Mo₂V₂)C₃, (Mo₂Nb₂)C₃, (Mo₂Ta₂)C₃, (W₂Ti₂)C₃, (W₂Zr₂)C₃, (W₂Hf₂)C₃

Typically in the above formula, M can be titanium or vanadium and X can be a carbon atom or a nitrogen atom. For example, the MAX phase is Ti₃AlC₂ and MXene is Ti₃C₂Tₛ (in other words, M is Ti, X is C, n is 2, and m is 3).

It is noted, in the present invention, MXene may contain remaining A atoms at a relatively small amount, for example, at 10 mass % or less with respect to the original amount of A atoms. The remaining amount of A atoms can be preferably 8 mass % or less, and more preferably 6 mass % or less. However, even if the residual amount of A atoms exceeds 10 mass %, there may be no problem depending on the application and use conditions of conductive films.

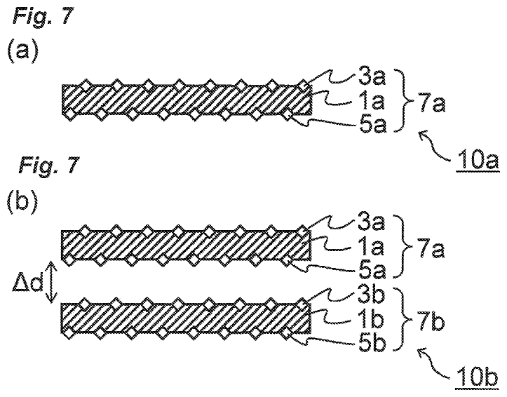

As schematically illustrated in FIG. 7, the MXene particles 10 synthesized in this manner may be particles of a layered material (as examples of the MXene particles 10, the MXene particles 10a in one layer are illustrated in FIG. 7(a), and the MXene particles 10b in two layers are illustrated in FIG. 7(b), but the present invention is not limited to these examples) including one or plural MXene layers 7a and 7b. More specifically, the MXene layers 7a, 7b have layer bodies (MₘXₙ layers) 1a, 1b represented by MₘXₙ, and modifiers or terminals T 3a, 5a, 3b, 5b existing on the surfaces of the layer bodies 1a, 1b (more specifically, on at least one of both surfaces, facing each other, of each layer). Therefore, the MXene layers 7a, 7b are also represented by “MₘXₙTₛ,” wherein s is any number. The MXene particles 10 may be one in which such MXene layers are individually separated and exist in one layer (the single layer structure illustrated in FIG. 7(a), so-called single-layer MXene particles 10a), particles of a laminate in which a plurality of MXene layers are stacked apart from each other (the multilayer structure illustrated in FIG. 7(b), so-called multilayer MXene particles 10b), or a mixture thereof. The MXene particles 10 may be particles (which may also be referred to as powders or flakes) as an aggregate formed of the single-layer MXene particles 10a and/or the multilayer MXene particles 10b. In the case of multilayer MXene particles, two adjacent MXene layers (for example, 7a and 7b) do not necessarily have to be completely separated from each other, and may be partially in contact with each other.

Although not limiting the present embodiment, the thickness of each layer of MXene (which corresponds to the MXene layers 7a, 7b) is, for example, 0.8 nm to 5 nm, and particularly 0.8 nm to 3 nm (which can vary mainly depending on the number of M atom layers included in each layer), and the maximum dimension in a plane (two-dimensional sheet plane) parallel to the layer is, for example, 0.1 μm to 200 μm, and particularly 1 μm to 40 μm. When the MXene particles are particles of a laminate (multilayer MXene), for each laminate, an interlayer distance (alternatively, a void dimension, indicated by Ad in FIG. 7(b)) is, for example, 0.8 nm to 10 nm, particularly 0.8 nm to 5 nm, and more particularly about 1 nm. The total number of layers may be 2 or more, and is, for example, 50 to 100,000, particularly 1,000 to 20,000. The thickness in the lamination direction is, for example, 0.1 μm to 200 μm, particularly 1 μm to 40 μm. The maximum dimension in a plane (two-dimensional sheet plane) perpendicular to the lamination direction is, for example, 0.1 μm to 100 μm, and particularly 1 μm to 20 μm. Note that these dimensions can be obtained as a number average dimension (for example, a number average of at least 40) based on a photograph of a scanning electron microscope (SEM), a transmission electron microscope (TEM), or an atomic force microscope (AFM) or a distance in a real space calculated from a position on a reciprocal lattice space of a (002) plane measured by an X-ray diffraction (XRD) method.

Then, a slurry S containing the MXene particles in a liquid medium is prepared. The above description of Embodiment 1 similarly applies to the concentration of MXene particles in the slurry S.

With the slurry S thus prepared, the method described above in Embodiment 1 is performed to produce the film 30. The film 30 of the present embodiment is a conductive film containing MXene particles 10. The conductive film 30 may or may not substantially contain components derived from the liquid medium of the slurry S. The conductive film 30 contains the MXene particles 10 and optionally a component derived from a remaining liquid medium, and may be substantially free of other components (for example, a so-called binder). Alternatively, the slurry S may contain any appropriate component (the polymer described above in Embodiment 1) in addition to the particles 10 of the layered material and the liquid medium, and the conductive film 30 obtained using such slurry may further contain the component.

As schematically illustrated in FIG. 6, the MXene particles 10 exist in a relatively aligned state in the finally obtained conductive film 30, and more specifically, there are many particles 10 in which two-dimensional sheet surfaces of MXene (planes parallel to the layer of MXene) are relatively aligned (preferably parallel) with respect to the substrate surface 31a (in other words, the main surface of the film 30). That is, the conductive film 30 having high orientation of the MXene particles 10 in the conductive film 30 can be obtained. The conductive film of the present embodiment has an χ-axis direction rocking curve half-value width of 20° or less with respect to a peak of a (00l) plane (l is a natural number multiple of 2) obtained by X-ray diffraction measurement of the conductive film, and has a conductivity of 3,000 S/cm or more.

Although the present invention is not bound by any theory, it can be considered that a conductive film containing MXene particles can be formed by stacking MXene particles (the single-layer MXene particles and/or the multilayer MXene particles may be the MXene particles, and the single-layer MXene particles may also be referred to as “nanosheets” or “single flakes”.), and the conductivity of the conductive film is controlled by the orientation of the MXene particles. In order to obtain a conductive film having high conductivity, it is preferable that the MXene particles are oriented as parallel and uniform as possible, in other words, the orientation is high. As a measure indicating the orientation of the MXene particles, the χ-axis direction rocking curve half-value width (hereinafter, also simply referred to as “χ-axis direction rocking curve half-value width”) with respect to the peak of the (00l) plane (l is a natural number multiple of 2) obtained by X-ray diffraction measurement can be applied. The narrower the χ-axis direction rocking curve half-value width is, the higher the orientation of the MXene particles in the conductive film is.

The χ-axis direction rocking curve half-value width is obtained with respect to the peak of the (00l) plane (l is a natural multiple of 2, for example, 1=2, 4, 6, 8, 10, 12, . . . ) of MXene contained in the conductive film by measuring X-ray diffraction (XRD) of the conductive film, and is more specifically determined as follows. When the conductive film containing MXene is subjected to XRD measurement, a peak of a (00l) plane of MXene is observed in an XRD profile obtained by θ-axis direction scanning. In the XRD profile of the θ-axis direction scan, a plurality of peaks of the (00l) plane of MXene can be observed, and any peak may be adopted, but typically, a peak of the (0010) plane (l=10) can be adopted. Then, the χ-axis direction rocking curve is obtained by the χ-axis direction scan fixed at 2θ at which the peak of the (00l) plane is obtained. The width (°) of the χaxis angle when one peak is observed in the χ-axis direction rocking curve and the intensity of this peak is halved is defined as a “χ-axis direction rocking curve half-value width”.

For the XRD measurement, for example, a fine X-ray diffraction (μ-XRD) apparatus equipped with a two-dimensional detector can be used, and the two-dimensional X-ray diffraction image obtained thereby can be converted into one dimension (appropriately fitted) to obtain the XRD profile (the vertical axis is intensity and the horizontal axis is 2θ, commonly referred to as the “XRD profile.”) of the 0-axis direction scan and the χ-axis direction locking curve profile (the vertical axis is intensity, and the horizontal axis is χ.) with respect to a predetermined 2θ.

The (00l) plane of MXene basically indicates the crystal c-axis direction of MXene, and the peak of the (00l) plane can be observed in the XRD profile of the θ-axis direction scan. In the XRD profile of the scan in the θ-axis direction, a peak of the (00l) plane can be observed at θ corresponding to the length d of the periodic structure (periodic structure along stacking direction in stacking structure of single-layer MXene and/or multilayer MXene) of MXene according to the Bragg diffraction condition (2d·sin θ=n·λ (n is a natural number, and λ, is a wavelength.)), but the length d of the periodic structure can be shifted by the interlayer distance (the distance refers to a distance between any two adjacent MXene layers in the conductive film regardless of the single-layer MXene and the multilayer MXene.) of MXene, the thickness of the MXene layer, and the like. When the above formula: MₘXₙ is MXene represented by Ti₃C₂, the peak of the (0010) plane is observed as a peak near 2θ=35 to 40° (approximately 36°). When the χ-axis direction locking curve is acquired with respect to the peak of the (00l) plane, the intensity is maximized (a peak is observed) at an angle perpendicular to (or near) the principal surface of the conductive film. As the crystal c-axis direction of MXene is aligned, the strength is significantly reduced when the MXene is deviated from the perpendicular angle. Therefore, the smaller the half-value width of the peak in the χ axis direction rocking curve, the more aligned the crystal c axis direction of MXene, in other words, the higher the orientation (refer to FIG. 6).

The conductive film of the present embodiment has a χ-axis direction rocking curve half-value width of 20° or less, so that high conductivity (3,000 S/cm or more) can be obtained. The χ-axis direction rocking curve half-value width may preferably be 15° or less, and the lower limit thereof is not particularly limited, but may be, for example, 3° or more.

Specifically, the conductive film of the present embodiment has the conductivity of 3,000 S/cm or more. The conductivity of the conductive film may be preferably 10,000 S/cm or more, and there is no particular upper limit, but may be, for example, less than 12,000 S/cm. The conductivity can be calculated from the measured values obtained by measuring the resistivity and the thickness of the conductive film.

The conductive film of the present embodiment may be in the form of a so-called film, and specifically, it may have two main surfaces facing each other. As to the conductive film, its thickness, its shape and dimensions when viewed in a plan view, and the like can be appropriately selected depending on the use of the conductive film.

The conductive film of the present embodiment can be used for any suitable application. For example, it may be used in applications where maintaining high conductivity is required, such as electrodes or electromagnetic shield (EMI shield) in any suitable electric device.

The electrode is not particularly limited, and may be, for example, a capacitor electrode, a battery electrode, a bioelectrode, a sensor electrode, an antenna electrode, an electrolysis electrode, or the like. By using the conductive film of the present embodiment, it is possible to obtain a large-capacity capacitor and battery, a low-impedance bioelectrode, a highly sensitive sensor, an antenna, and an electrode for electrolysis having a low cost even with a smaller volume (device occupied volume).

The capacitor may be an electrochemical capacitor. The electrochemical capacitor is a capacitor using capacitance developed due to a physicochemical reaction between an electrode (electrode active material) and ions (electrolyte ions) in an electrolytic solution, and can be used as a device (power storage device) that stores electric energy. The battery may be a repeatedly chargeable and dischargeable chemical battery. The battery may be, for example, but not limited to, a lithium ion battery, a magnesium ion battery, a lithium sulfur battery, a sodium ion battery, or the like.

The bioelectrode is an electrode (biosignal sensing electrode) for acquiring a biosignal. The bioelectrode may be, for example, but not limited to, an electrode for measuring electroencephalogram (EEG), electrocardiogram (ECG), electromyogram (EMG), electrical impedance tomography (EIT). The bioelectrode can be used, for example, in contact with the skin of the human body, but is not limited thereto.

The sensor electrode is an electrode (sensing electrode) for detecting a target substance, state, abnormality, or the like. The sensor may be, for example, but not limited to, a strain sensor, a gas sensor, a biosensor (a chemical sensor utilizing a molecular recognition mechanism of biological origin), or the like.

The conductive film containing the MXene particles can have flexibility and a piezoresistive effect, and can be suitably used for an electrode for a strain sensor, a bioelectrode (biosignal sensing electrode), and the like by using at least one of these. The conductive film having high orientation of the MXene particles can improve performance of an electrode for a strain sensor, a bioelectrode (biosignal sensing electrode), and the like utilizing flexibility and/or a piezoresistive effect.

The antenna electrode is an electrode for emitting an electromagnetic wave into a space and/or receiving an electromagnetic wave in the space.

The electrolysis electrode is an electrode to which a voltage is applied in order to bring about an electrolysis reaction by being immersed in an electrolyte solution, and may be, for example, a hydrogen generating electrode (which may have a catalytic function). The conductive film of the present embodiment can be produced by carrying out the method described above in Embodiment 1, whereby the conductive film can be formed at a time with a film thickness that can withstand practical use as an electrode for hydrogen generation, and the production cost of the conductive film can be reduced.

Particularly, by using the conductive film of the present embodiment, an electromagnetic shield having a high shielding rate (EMI shielding property) can be obtained. In general, the EMI shielding property is calculated with respect to the conductivity as shown in Table 1 on the basis of the following Equation (1):

$$SE = 50 + 10 log ( \frac{σ}{f} ) + 1.7 t \sqrt{σ f} \qquad ( 1 )$$

In Equation (1), SE is EMI shielding property (dB), σ is conductivity (S/cm), f is a frequency (MHz) of an electromagnetic wave, and t is a thickness (cm) of a film.

TABLE 1

| Conductivity (S/cm) | EMI shielding property (dB)* |
|---|---|
| 100 | 41 |
| 1,000 | 52 |
| 2,000 | 55 |
| 3,000 | 58 |
| 4,000 | 59 |
| 5,000 | 61 |
| 6,000 | 62 |
| 7,000 | 63 |
| 8,000 | 64 |
| 9,000 | 65 |
| 10,000 | 65 |

*Here, f = 1,000 MHz and t = 0.001 cm.

As understood from Table 1, when the conductivity is less than 3,000 S/cm, EMI shielding properties are reduced, but when the conductivity is 3,000 S/cm or more, high EMI shielding properties are obtained. According to the conductive film of the present embodiment, since the conductivity is 3,000 S/cm or more, in a case where the thickness is constant, higher EMI shielding properties can be obtained, or a sufficient EMI shielding effect can be obtained even if the thickness is reduced.

Although two embodiments of the present invention have been described in detail above, various modifications are possible. For example, in Embodiment 2, the case of using MXene as the layered material has been described, but it is considered that a conductive mechanism of MXene is similar to the conductive mechanism of other conductive layered materials such as graphene, and thus the qualitative description (action and/or effect) related to the conductivity of MXene in Embodiment 2 can be similarly applied to other conductive layered materials such as graphene. It should be noted that the conductive film according to the present invention may be produced by a method different from the producing method in the above-described Embodiment 1, and the method for producing a film according to the present invention is not limited only to one that provides the conductive film according to the above-described Embodiment 2.

### EXAMPLES

### Example 1

Example 1 relates to an example of producing a conductive film using an external mixing type multi-fluid nozzle, more particularly an external mixing vortex type multi-fluid (two-fluid) nozzle (refer to FIGS. 4 and 5), wherein MXene slurry is used. Preparation of MXene Slurry

Ti₃AlC₂ particles were prepared as MAX particles by a known method. These Ti₃AlC₂ particles (powder) were added to 9 mol/L hydrochloric acid together with LiF (for 1 g of Ti₃AlC₂ particles, 1 g of LiF and 10 mL of 9 mol/L hydrochloric acid were used.), and stirred with a stirrer at 35° C. for 24 hours to obtain a solid-liquid mixture (suspension) containing a solid component derived from the Ti₃AlC₂ particles. Using the solid-liquid mixture, an operation of separating and removing a supernatant liquid by washing with pure water and decantation using a centrifuge (remaining precipitate excluding the supernatant is washed again) was repeated about 10 times. Then, the mixture obtained by adding pure water to the precipitate was stirred with an automatic shaker for 15 minutes, and then subjected to centrifugal separation operation for 5 minutes with a centrifuge to separate the mixture into a supernatant and a precipitate, and the supernatant was separated and removed by centrifugal dehydration. As a result, dilution was performed by adding pure water to the remaining precipitate excluding the supernatant, thereby obtaining a crude purification slurry. It is understood that the roughly purified slurry may contain, as MXene particles, single-layer MXene particles and multilayer MXene particles that are not formed into a single layer due to insufficient layer separation (delamination), and may further contain impurities other than MXene particles (crystals of unreacted MAX particles and by-products derived from etched A atoms (for example, crystals of AlF₃), and the like).

The roughly purified slurry obtained above was placed in a centrifuge tube, and centrifuged with relative centrifugal force (RCF) of 2,600×g for 5 minutes using a centrifuge. The supernatant thus centrifuged was recovered by decantation to obtain a purified slurry. It is understood that the purified slurry contains a large amount of single-layer MXene particles as MXene particles. The remaining precipitate, excluding the supernatant, was not subsequently used.

The purified slurry obtained above was placed in a centrifuge tube, and centrifuged with the RCF of 3,500×g for 120 minutes using a centrifuge. The supernatant thus centrifuged was separated and removed by decantation. The separated and removed supernatant was not used thereafter. A clay-like substance (clay) was obtained as the remaining precipitate from which the supernatant was removed. As a result, a Ti₃C₂Tₛ-water dispersion clay was obtained as a MXene clay. The MXene clay and pure water were mixed in appropriate amounts to prepare MXene slurry having a solid content concentration (MXene concentration) of 84 mg/mL.

Spray Coating

As an external mixing type multi-fluid nozzle, an external mixing vortex type multi-fluid (two-fluid) nozzle (available from ATOMAX.INC, Atomax Nozzle AM 12 type) was used. The MXene slurry (solid content concentration: 84 mg/mL) prepared above was placed in a plastic syringe and set in a syringe pump (YSP-101 available from YMC CO., LTD.). The extrusion speed of the syringe pump was set to 5.0 mL/min, and the discharge port of the plastic syringe was connected to the liquid material (slurry) supply port of the external mixing type multi-fluid nozzle. On the other hand, the gas supply port of the external mixing type multi-fluid nozzle was connected to a supply source of compressed air (factory compressed air line) via a plastic hose, and the gas discharge pressure from the nozzle was adjusted to 0.45 MPa (gauge pressure).

Thereafter, the slurry and gas (air) were discharged from the external mixing type multi-fluid nozzle and sprayed onto a substrate (Lumirror (registered trademark) T 60 available from Toray Industries, Inc.) formed of a polyethylene terephthalate film. After spraying, the film was dried with a hand dryer (EH 5206 P-A available from Panasonic Corporation). The operations of spraying and drying were repeated 15 times in total. Thus, a conductive film was prepared on the substrate (PET film).

### Comparative Example 1

Comparative Example 1 relates to an example of producing a conductive film using an internal mixing type multi-fluid (two-fluid) nozzle (refer to FIG. 8).

Preparation of MXene Slurry

An MXene slurry having a solid content concentration (MXene concentration) of 84 mg/mL obtained in the same manner as in Example 1 was diluted with pure water to prepare an MXene slurry having a solid content concentration (MXene concentration) of 15 mg/mL.

Spray Coating

As an internal mixing type multi-fluid (two-fluid) nozzle, an air brush (Spray work HG air brush wide (trigger type) available from TAMIYA INC.) was used. The MXene slurry (solid concentration: 15 mg/mL) prepared above was placed in a coating material cup connected to a liquid material (slurry) supply port of an internal mixing type multi-fluid nozzle. On the other hand, the gas supply port of the internal mixing type multi-fluid nozzle was connected to a compressed air supply source (Air brush system No. 53, spray work power compressor 74553, available from TAMIYA INC.), and the gas discharge pressure from the nozzle was adjusted to 0.40 MPa (gauge pressure).

Thereafter, the slurry and gas (air) were discharged from the internal mixing type multi-fluid nozzle (by pulling a trigger of an air brush) and sprayed onto a substrate (Lumirror (registered trademark) T 60 available from Toray Industries, Inc.) formed of a polyethylene terephthalate film. After spraying, the film was dried with a hand dryer (EH 5206 P-A available from Panasonic Corporation). The operations of spraying and drying were repeated 120 times in total. Thus, a conductive film was prepared on the substrate (PET film).

(Evaluation)

Regarding the conductive film with a substrate (sample) of Example 1 and Comparative Example 1 prepared as described above, the conductive film was punched out or cut out together for each substrate (PET film), XRD measurement was performed using μ-XRD (AXS D8 DISCOVER with GADDS available from Bruker Corporation), and the χ-axis direction rocking curve half-value width was calculated. More specifically, a two-dimensional X-ray diffraction image of the conductive film was obtained by XRD measurement (characteristic X-ray: CuKα=1.54 Å), a peak at 20=35 to 40° (around 36°) in the XRD profile of θ-axis direction scan (a peak of a (0010) plane of MXene in which MₘXₙ is represented by Ti₃C₂) was examined, a χ-axis direction rocking curve was obtained for this peak, and a χ-axis direction rocking curve half-value width was calculated. The χ-axis direction rocking curve half-value width was an average value of the measured values at two points obtained by XRD measurement. The results are shown in Table 2.

In addition, the conductivity (S/cm) of the conductive film with a substrate was measured using a portion other than the portion punched out as described above in the conductive film with a substrate (sample) of Example 1 and Comparative Example 1 prepared as described above. More specifically, for the conductivity, the resistivity (surface resistivity) (Ω) and the thickness (μm) (obtained by subtracting the thickness of the substrate) were measured at three locations per sample, the conductivity (S/cm) was calculated from the average value of the measurements performed, and the arithmetic average value of the conductivities at the three locations thus obtained was adopted. For resistivity measurement, a low resistivity meter (Loresta AX MCP-T 370, manufactured by Mitsubishi Chemical Analytech) was used. A micrometer (MDH-25 MB, manufactured by Mitutoyo Corporation) was used for the thickness measurement. The results are also shown in Table 2.

TABLE 2

| | χ-axis direction rocking curve | Conductivity |
|---|---|---|
| | half-value width (°) | (S/cm) |
| Example 1 | 15.9 | 6708 |
| Comparative | 22.6 | 2386 |
| Example 1 | | |

Referring to Table 2, the conductive film of Example 1 had high orientation when the χ-axis direction rocking curve half-value width was 20° or less, and thus a high conductivity of 3,000 S/cm or more (more specifically, 6,000 S/cm or more) was obtained.

In Example 1, it is considered that by using an external mixing type multi-fluid nozzle, particularly an external mixing vortex type multi-fluid nozzle (refer to FIGS. 4 and 5), strong shear force can be applied to the MXene particles to solve aggregation of the MXene particles and overlap between the particles, and further, in a case where the particles have a multilayer structure, layer separation (delamination) can be performed by applying shear force energy larger than bond energy (the bond energy between the layers of the multilayer MXene is reported to be 1.0 to 3.3 J/m².) between the layers, so that the thickness in the direction perpendicular to the substrate surface is uniform, and high orientation (refer to FIG. 6) and high conductivity are obtained. In the external mixing type multi-fluid nozzle, nozzle clogging hardly occurs, and a slurry having a high solid content concentration of 30 mg/mL or more (that is, high viscosity) can be used as it is, which is suitable for industrial mass production.

Referring to Table 2 again, in the conductive film of Comparative Example 1, the χ-axis direction rocking curve half-value width was 20° or more, and the orientation was low, and therefore only a low conductivity of less than 3,000 S/cm (more specifically, less than 2,500 S/cm) was obtained.

It is considered that in Comparative Example 1, by using the internal mixing type multi-fluid nozzle (refer to FIG. 8), sufficient shear force could not be applied to the MXene particles, the MXene particles were supplied as they were (for example, the single-layer MXene is left as it is, and the multilayer MXene particles are bulky.) onto the substrate, the thickness in the direction perpendicular to the substrate surface was uneven, the orientation was lowered (refer to FIG. 9), and consequently only a low conductivity was obtained. In addition, in the internal mixing type multi-fluid nozzle, since the slurry and the gas are mixed in the nozzle, nozzle clogging is unlikely to occur, and a slurry having a high solid content concentration of 30 mg/mL or more (that is, high viscosity) cannot be used as it is, and it is necessary to dilute and use the slurry, which is not suitable for industrial mass production.

### Example 2

Example 2 is a modification of Example 1 and relates to an example using a MXene-polymer composite slurry.

Preparation of MXene Slurry

In the same manner as in Example 1, Ti₃AlC₂ particles were prepared as MAX particles by a known method. These Ti₃AlC₂ particles (powder) were added to 48 mass % hydrofluoric acid (aqueous hydrogen fluoride solution) and 35 mass % hydrochloric acid, 18 mL of pure water was added (for 1 g of the Ti₃AlC₂ particles, 2 mL of 48 mass % hydrofluoric acid and 12 mL of 35 mass % hydrochloric acid were used.), and the mixture was stirred with a stirrer at 35° C. for 24 hours to obtain a solid-liquid mixture (suspension) containing a solid component derived from the Ti₃AlC₂ particles. Using the solid-liquid mixture, an operation of separating and removing a supernatant liquid by washing with pure water and decantation using a centrifuge (remaining precipitate excluding the supernatant is washed again) was repeated about 10 times. Then, the mixture obtained by adding pure water to the precipitate was stirred with an automatic shaker for 15 minutes, and then subjected to centrifugal separation operation for 5 minutes with a centrifuge to separate the mixture into a supernatant and a precipitate, and the supernatant was separated and removed by centrifugal dehydration. As a result, dilution was performed by adding pure water to the remaining precipitate excluding the supernatant, thereby obtaining a crude purification slurry. It is understood that the roughly purified slurry may contain, as MXene particles, single-layer MXene particles and multilayer MXene particles that are not formed into a single layer due to insufficient layer separation (delamination), and may further contain impurities other than MXene particles (crystals of unreacted MAX particles and by-products derived from etched A atoms (for example, crystals of AlF₃), and the like).

The roughly purified slurry obtained above was placed in a centrifuge tube, and centrifuged with relative centrifugal force (RCF) of 2,600×g for 5 minutes using a centrifuge. The supernatant thus centrifuged was recovered by decantation to obtain a purified slurry. It is understood that most of the MXene particles contained in the purified slurry are single-layer MXene particles. The remaining precipitate, excluding the supernatant, was not subsequently used.

The purified slurry obtained above was placed in a centrifuge tube, and centrifuged with the RCF of 3,500×g for 120 minutes using a centrifuge. The supernatant thus centrifuged was separated and removed by decantation. The separated and removed supernatant was not used thereafter. A clay-like substance (clay) was obtained as the remaining precipitate from which the supernatant was removed. As a result, a Ti₃C₂Tₛ-water dispersion clay was obtained as a MXene clay. The MXene clay and pure water were mixed in appropriate amounts to prepare MXene slurry having a solid content concentration (MXene concentration) of about 34 mg/mL.

Preparation of MXene-Polymer Composite Slurry

The MXene slurry (solid concentration: 34 mg/mL) prepared above was collected in an amount of 31.3907 g. A 35 mass % polyurethane dispersion (D 4090 available from Dainichiseika Color & Chemicals Mfg. Co., Ltd.) diluted 100 times with pure water was collected in an amount of 18.6136 g, and mixed with the MXene slurry collected above. The mixture was shaken on a shaker for 15 minutes to prepare a MXene-polymer composite slurry.

Spray Coating

As an external mixing type multi-fluid nozzle, an external mixing vortex type multi-fluid (two-fluid) nozzle (available from ATOMAX.INC, Atomax Nozzle AM 12 type) was used. The MXene-polymer composite slurry prepared above was placed in a plastic syringe and set in a syringe pump (YSP-101 available from YMC CO., LTD.). The extrusion speed of the syringe pump was set to 5.0 mL/min, and the discharge port of the plastic syringe was connected to the liquid material (slurry) supply port of the external mixing type multi-fluid nozzle. On the other hand, the gas supply port of the external mixing type multi-fluid nozzle was connected to a supply source of compressed air (factory compressed air line) via a plastic hose, and the gas discharge pressure from the nozzle was adjusted to 0.45 MPa (gauge pressure).

Thereafter, the slurry and gas (air) were discharged from the external mixing type multi-fluid nozzle and sprayed onto a substrate (Lumirror (registered trademark) T 60 available from Toray Industries, Inc.) formed of a polyethylene terephthalate film. After spraying, the film was dried with a hand dryer (EH 5206 P-A available from Panasonic Corporation). The operations of spraying and drying were repeated 30 times in total. Thus, a conductive film was prepared on the substrate (PET film).

(Evaluation)

The conductive film with a substrate (sample) of Example 2 prepared above was evaluated in the same manner as described above. The results are shown in Table 3.

TABLE 3

| | χ-axis direction rocking curve | Conductivity |
|---|---|---|
| | half-value width (°) | (S/cm) |
| Example 2 | 8.2 | 10742 |

Referring to Table 3, the conductive film of Example 2 had high orientation when the χ-axis direction rocking curve half-value width was 20° or less, and thus high conductivity of 3,000 S/cm or more (more specifically, 10,000 S/cm or more) was obtained. In the conductive film of Example 2, the smaller χ-axis direction rocking curve half-value width and the higher conductivity were obtained as compared with the conductive film of Example 1, which is considered to be due to the difference in the method for etching the MAX particles.

The method for producing a film of the present invention can be used for obtaining a film including particles of a layered material required to have high orientation. The conductive film of the present invention can be used in any suitable application, and can be particularly, preferably used, for example, as electrodes or electromagnetic shield in electrical devices.

### DESCRIPTION OF REFERENCE SIGNS

1a, 1b: Layer body (MₘXₙ layer)

3a, 5a, 3b, 5b: Modifier or terminal T

7a, 7b: MXene layer

10, 10a, 10b: MXene (layered material) particles

20: Nozzle

20a, 20b, 20c: External mixing type multi-fluid nozzle

30: Film (conductive film)

31: Substrate

31a: Substrate surface

120: Internal mixing type multi-fluid nozzle

S: Slurry

G: Gas

1. A method for producing a film containing particles of a layered material including one or plural layers, the method comprising:
separately discharging a slurry containing particles of a layered material in a liquid medium and a gas from a nozzle;
causing the slurry and the gas to collide with each other outside the nozzle; and
depositing the particles of the layered material on a substrate to form the film.

2. The method for producing a film according to claim 1, wherein a concentration of the particles of the layered material in the slurry is 30 mg/mL or more.

3. The method for producing a film according to claim 1, wherein a concentration of the particles of the layered material in the slurry is 30 mg/mL to 200 mg/mL.

4. The method for producing a film according to claim 2, wherein the nozzle has a configuration in which the slurry and the gas collide with each other in a vortex outside the nozzle.

5. The method for producing a film according to claim 1, wherein the nozzle has a configuration in which the slurry and the gas collide with each other in a vortex outside the nozzle.

6. The method for producing a film according to claim 1,
wherein the one or plural layers include a layer body represented by:
MₘXₙ
wherein M is at least one metal of Group 3, 4, 5, 6, or 7,
X is a carbon atom, a nitrogen atom, or a combination thereof,
n is 1 to 4, and
m is more than n and 5 or less, and
a modifier or terminal T exists on a surface of the layer body, wherein T is at least one selected from the group consisting of a hydroxyl group, a fluorine atom, a chlorine atom, an oxygen atom, or a hydrogen atom.

7. The method for producing a film according to claim 1, wherein the produced film has an χ-axis direction rocking curve half-value width for a peak of a (00l) plane obtained by X-ray diffraction measurement of the film is 20° or less, where the l of the (00l) plane is a natural number multiple of 2.

8. The method for producing a film according to claim 1, wherein the film has a conductivity of 3,000 S/cm or more.

9. The method for producing a film according to claim 1, wherein the film has a conductivity of 10,000 S/cm or more.

10. A conductive film comprising:
particles of a layered material including one or plural layers,
wherein the one or plural layers include a layer body represented by:
MₘXₙ
wherein M is at least one metal of Group 3, 4, 5, 6, or 7,
X is a carbon atom, a nitrogen atom, or a combination thereof,
n is 1 to 4, and
m is more than n and 5 or less, and
a modifier or terminal T exists on a surface of the layer body, wherein T is at least one selected from the group consisting of a hydroxyl group, a fluorine atom, a chlorine atom, an oxygen atom, or a hydrogen atom, and
an χ-axis direction rocking curve half-value width for a peak of a (00l) plane obtained by X-ray diffraction measurement of the conductive film is 20° or less, where the l of the (00l) plane is a natural number multiple of 2, and
wherein the conductive film has a conductivity of 3,000 S/cm or more.

11. The conductive film according to claim 10, wherein the conductivity is 10,000 S/cm or more.

12. An electrode comprising the conductive film of claim 10.

13. An electromagnetic shield comprising the conductive film of claim 10.
